(19) United States
(12) Patent Application Publication
(10) Pub. No.: US 2006/0197859 A1
(43) Pub. Date: Sep. 7, 2006

(54) Solid-state image sensor having its photosensitive cells broadened in area

(75) Inventor: Kazuya Oda, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/354,081

(22) Filed: Feb. 15, 2006

(30) Foreign Application Priority Data
Mar. 7, 2005 (JP) 2005-61905
Feb. 2, 2006 (JP) 2006-25915

(51) Int. Cl. H04N 5/335

(52) U.S. Cl. 348/311

(57) ABSTRACT

An image pickup apparatus includes a solid-state image sensor having vertical transfer paths, which are formed every other column and therefore reduced in number to one-half of the conventional vertical transfer paths. The resulting idle regions are added to the photosensitive areas of photosensitive cells for thereby broadening the photosensitive areas, insuring sufficient signal charges even when the number of pixels is increased. Transfer gates each are positioned between a particular photosensitive cell and a particular column transfer path adjacent thereto at a side contacting the column transfer path, so that signal charges are vertically transferred without the mixture of colors.

### BACKGROUND OF THE INVENTION

1. Field of the Invention

The present invention relates to a solid-state image sensor and an image pickup apparatus using the same. More specifically, the present invention relates to a solid-state image sensor having an array of photosensitive cells generating signal charges in response to the amount of light incident thereto to output an electric signal derived from the signal charges. Also specifically, the present invention relates to an image pickup apparatus comprising the above image sensor and configured to pick up an image to produce corresponding image information to record such image information, the apparatus being implemented as, but not limited to, an electric still camera, image input apparatus, movie or a cellular phone.

2. Description of the Background Art

U.S. Pat. No. 6,236,434 to Yamada, for example, discloses a solid-state image sensor including an array of photosensitive cells arranged in the following unique pattern. The photosensitive cells on one row or line are shifted from the photosensitive cells on another row or line adjoining it by substantially one-half of a pixel, or layout, pitch. Also, vertical transfer paths are formed on a semiconductor substrate in such a zigzag manner as to meander between nearby photosensitive cells; between ones of the photosensitive cells adjoining each other in the direction of rows or lines two vertical transfer paths are positioned while between ones of the photosensitive cells adjoining each other in the diagonal direction one vertical transfer path is positioned. With this arrangement, it is possible to optimize the spatial sampling points of an image captured and effect simultaneous readout of whole pixels.

In the image sensor taught in the above document, signal charges generated in photosensitive cells positioned above and below non-photosensitive or invalid regions in the vertical direction of its imaging area are used to generate signal charges for the invalid regions in the form of virtual pixels. This is successful to equivalently implement an image resolution two times as great as the number of photosensitive cells actually arranged on the image sensor for thereby producing a high-quality image signal that includes a minimum of moire and other false signals.

With the unique arrangement of photosensitive cells stated above, it is possible to broaden the range of configurations of color filters and those of microlenses applicable to a solid-state image sensor and therefore to increase the photo-sensitive efficiency of the image sensor. This, in turn, reduces the non-photosensitive or invalid regions as far as possible to thereby promote high integration of the image sensor. Further, the above solid-state image sensor is free from a difference in characteristic between photosensitive cells ascribable to relative displacements between photosensitive cells and vertical transfer paths, which are brought about on the fabrication process. The fabrication of such solid-state image sensors themselves is relatively easy because the conventional technology for producing a double-layer-deposited electrode structure is available.

Today, there is an increasing demand for a further increase in the number of pixels included in a solid-state image sensor. However, the number of pixels cannot be increased without reducing the cell size, i.e. the size of the individual pixel and therefore the area ratio of channel stops separating the photosensitive cells from the vertical transfer paths as well as machining accuracy.

### SUMMARY OF THE INVENTION

It is an object of the present invention to provide a solid-state image sensor that allows the cell size to be reduced for increasing the number of pixels while preserving the conventional characteristic, and an image pickup apparatus using the same.

A solid-state image sensor of the present invention includes an array of photosensitive cells arranged on a semiconductor substrate for generating signal charges by photoelectric conversion. The photosensitive cells on any one row are arranged at a pitch and shifted in the direction of the row by an interval from the photosensitive cells on rows adjoining the above row. A plurality of column transfer paths transfer signal charges read out from the photosensitive cells in the direction of column. Transfer gates cause the signal charges stored in the photosensitive cells to be read out to the column transfer paths. A row transfer path transfers the signal charges input from the column transfer paths in the direction of row. The column transfer paths each are formed at one side of every other column of the photosensitive cells. The transfer gates each are positioned between a particular photosensitive cell and a particular column transfer path adjacent thereto at a side contacting the particular column transfer path.

Also, an image pickup apparatus of the present invention includes a solid-state image sensor having the configuration described above to produce an image signal. The apparatus further includes a driver for generating a drive signal for driving the image sensor and feeding the drive signal to the image sensor, a timing signal generator for providing the driver with a timing for generating the timing signal, a controller for controlling the operation of the timing signal generator, a control panel for feeding an operation signal to the controller, and a signal processor for processing the image signal output from the image sensor. Again, the column transfer paths each are formed at one side of every other column of photosensitive cells while the transfer gates each are positioned between a particular photosensitive cell and a particular column transfer path adjacent thereto at a side contacting the particular column transfer path.

### BRIEF DESCRIPTION OF THE DRAWINGS

The objects and features of the present invention will become more apparent from consideration of the following detailed description taken in conjunction with the accompanying drawings in which:

FIG. 1 is a view schematically showing part of a solid-state image sensor embodying the present invention and implemented as a CCD image sensor;

FIG. 2 is a view similar to FIG. 1, schematically showing an optimized form of the image sensor shown in FIG. 1;

FIG. 3 is a timing chart showing drive signals for the image sensor of FIG. 1 or 2;

FIG. 4 is a timing chart useful for understanding the application of the drive signals shown in FIG. 3, lines (B) through (E), in a usual readout mode;

FIG. 5 is a potential chart schematically showing how packets are formed and shifted in response to the drive signals of FIG. 3;

FIG. 6 schematically shows part of an alternative embodiment of the solid-state image sensor in accordance with the present invention and also implemented as a CCD image sensor;

FIG. 7 schematically shows part of an alternative arrangement of color filter segments included in the image sensor of FIG. 6;

FIG. 8 schematically shows part of an implementation included in the arrangement of FIG. 7 for coping with color shading; and

FIG. 9 is a schematic block diagram showing a digital cameral including the solid-state image sensor of the present invention.

### DESCRIPTION OF THE PREFERRED EMBODIMENTS

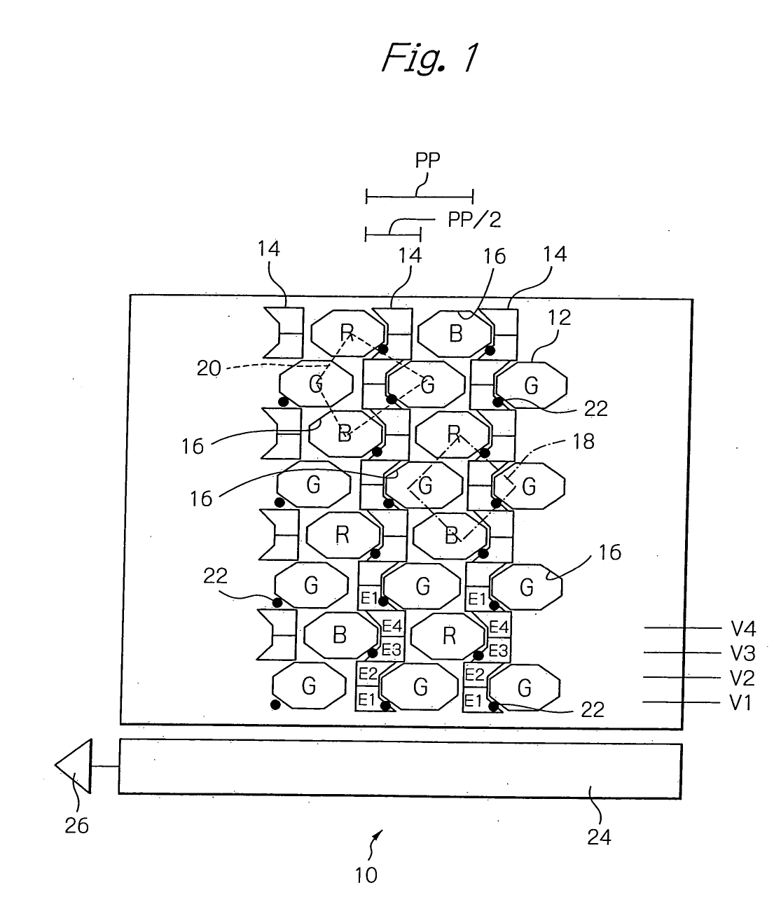

Referring to FIG. 1 of the accompanying drawings, a solid-state image sensor embodying the present invention is implemented by a charge-coupled device (CCD) image sensor by way of example. Arrangements not directly relevant to the understanding of the present invention are not shown in the figures, and detailed description thereof will not be made.

As shown, the CCD image sensor, generally 10, includes an array of photosensitive cells 12 forming pixels or actual pixels. It is a common practice with a CCD image sensor to shift photosensitive cells on one of nearby rows or lines from photosensitive cells on the other row or line by basically one-half of a pixel, or layout, pitch for thereby densely arranging the photosensitive cells, as stated previously. In the figures, there are shown only part or some of the photosensitive cells and transfer paths merely for simplicity although in practice image sensors of course include a lot of photosensitive cells and corresponding charge transfer paths.

Also, it has been customary with a CCD image sensor to form vertical transfer paths at both sides of each column of photosensitive cells. By contrast, in the illustrative embodiment, vertical, or column, transfer paths 14 for transferring signal charges are formed zigzag at only one side of every other column of photosensitive cells, so that, as seen from FIG. 1, the vertical transfer paths 14 are successfully reduced in number to one-half of the conventional vertical transfer paths. The idle regions 16 of the CCD image sensor 10, heretofore occupied by vertical transfer paths, i.e. the regions 16 from which some vertical transfer paths have been removed, are used as part of photosensitive regions 16 belonging to the photosensitive cells 12. The photosensitive regions 16 of the illustrative embodiment are therefore broader than conventional photosensitive regions in the horizontal direction, increasing the total photosensitive area of the CCD image sensor 10.

By enlarging the individual photosensitive region 16, as stated above, it is possible to increase the saturation amount of signal charge to be stored, i.e. storage capacity of signal charge, in the photosensitive cell 12 associated with the photosensitive region 16. More specifically, the increase of the pixels, i.e. photosensitive cells, for the purpose of improving image quality would heretofore cause a photosensitive area which would otherwise be available with the individual photosensitive cell of a conventional CCD image sensor to decrease correspondingly. By contrast, the photosensitive region 16 of each photosensitive cell 12 unique to the illustrative embodiment makes up for such a decrease in photosensitive area for thereby increasing the amount of signal charge capable of being caught by and stored in the photosensitive cell 12. Stated another way, the illustrative embodiment makes it possible to increase the saturation amount of signal charge to such a degree that the amount of signal charges corresponding to ISO (International Standards Organization) sensitivity of about 80 to about 100 covers even the conventional ISO sensitivity of up to 200.

Each photosensitive cell 12 has its optical aperture configured in the same manner as a conventional aperture, although not shown specifically. A color filter, not shown, has color filter segments covering the apertures of the photosensitive cells 12 and arranged in the conventional G (green) square lattice, RB (red and blue) full-checker pattern. In the illustrative embodiment, the area of each aperture is enlarged in the right-and-left direction in comparison to the conventional one, so that vignetting and therefore shading ascribable to the characteristic of converging light beams is reduced.

In the prior art CCD image sensor stated earlier, when the centers of the pixels adjoining each other are connected together, they virtually form a square rotated by 45 degrees, as indicated by a dash-and-dot line 18 in FIG. 1. In the illustrative embodiment, the center of the adjoining pixels formed by the photosensitive cells 12, which are elongated in the right-and-left direction, form a rectangle when connected together, as indicated by a dashed line 20 in FIG. 1. This suggests that the photosensitive cells or pixels 12, which appear to generally lie on the same column, i.e. which are aligned generally in the vertical direction, should preferably be arranged at, i.e. shifted by, about one-third to one-fourth of the pixel pitch PP instead of the conventional one-half of the pixel pitch PP as depicted with PP/2. For example, in FIG. 1, with respect to the vertical, or column, direction, the photosensitive cells 12 to which colors R and B are assigned are shifted in the horizontal, or row, direction, from the photosensitive cells to which color G is assigned by substantially one-third of the pixel pitch PP.

While all the idle regions may be replaced with the photosensitive regions 16 in the illustrative embodiment, they may alternatively be shared by the photosensitive regions 16 and vertical transfer paths 14 configured to vertically transfer signal charges read out from the photosensitive cells 12. This successfully increases the width of each vertical transfer path 14 and therefore the amount of signal charges to be transferred thereby. In such an alternative case, the idle regions should preferably be evenly allotted to the photosensitive regions 16 and transfer paths 14.

In the illustrative embodiment, the number of vertical transfer paths 14 is one-half of number of the vertical transfer paths included in the conventional CCD image sensor, as stated earlier. To effectively use such a number of limited number of vertical transfer paths 14, the photosensitive cells 12 are provided with respective transfer gates 22 at the side contacting the vertical transfer path 14 which they share. In FIG. 1, the transfer gates 22 are represented by dots.

The signal charges read out from the photosensitive cells 12 are transferred by the vertical transfer paths 14 to a horizontal, or row, transfer path 24 perpendicular to the vertical transfer paths 14 and further transferred by the path 24 to an output amplifier 26 at a high transfer rate. The output amplifier 26, implemented as a floating diffusion amplifier, converts the signal charges sequentially input thereto via the horizontal transfer path 24 to corresponding analog voltages.

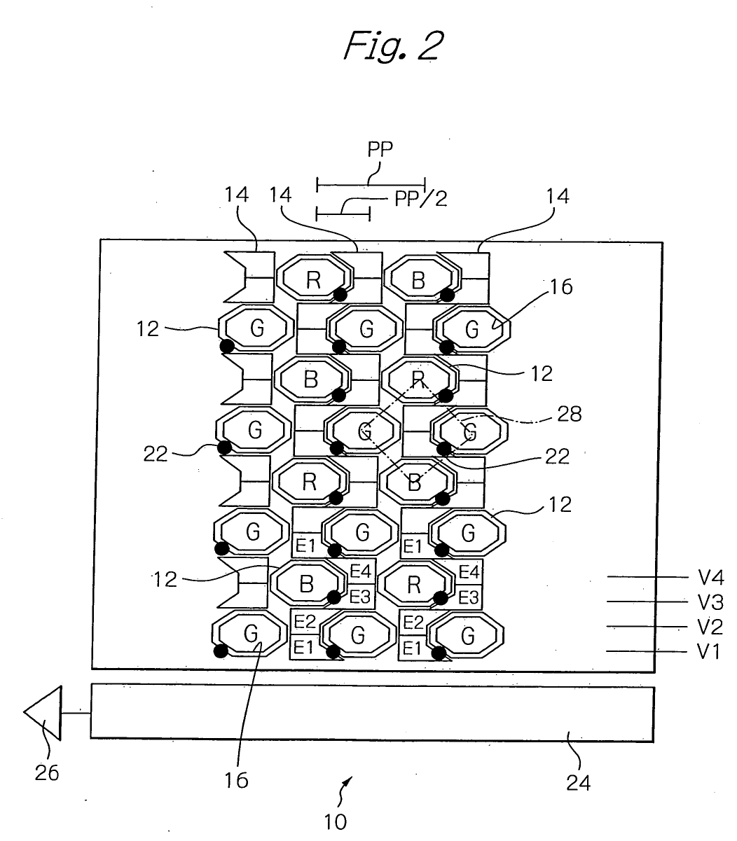

FIG. 2 shows an optimized form of the CCD image sensor 10 shown in FIG. 1. As shown, the shape of each photosensitive cells 12 and that of each vertical transfer path 14 are so optimized as to have an even area ratio, as mentioned earlier, so that the centers of adjoining pixels form a square 28 as in the conventional configuration when connected together by virtual lines. When priority is given to contribution to the photosensitive regions 16, the shift pixels by one-third to one-fourth of the pixel pitch stated earlier is desirable in terms of shift amount.

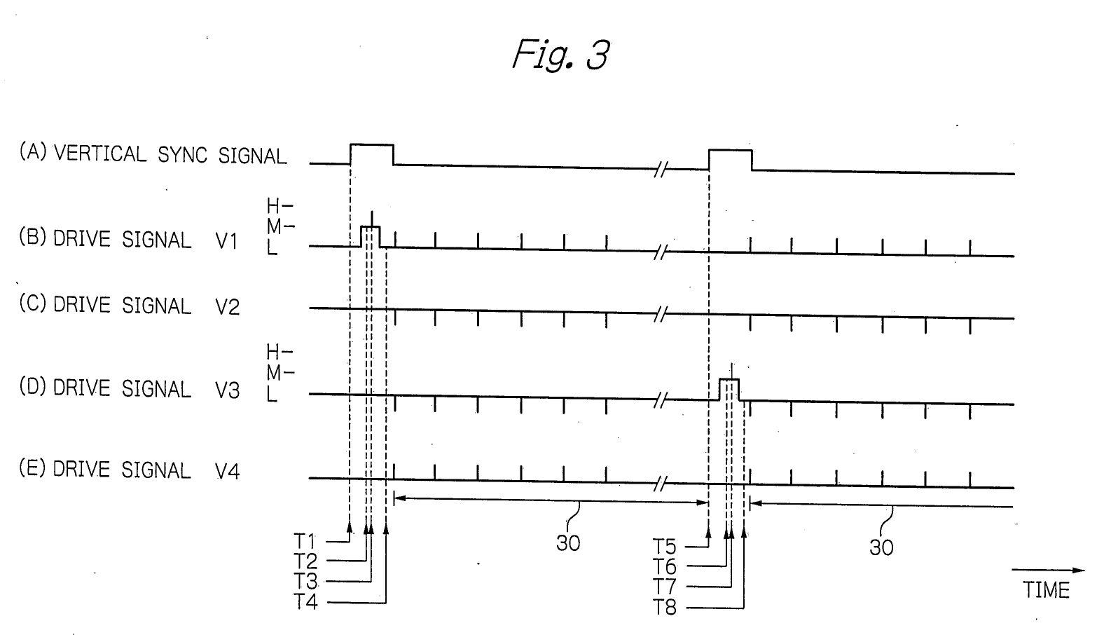

Reference will be made to FIG. 3 for describing a specific operation of the CCD image sensor 10. It has been customary with a CCD image sensor to read out signal charges from its photosensitive cells by simultaneous readout of whole pixels. Simultaneous readout of whole pixels, however, is not applicable to the CCD image sensor 10 of the illustrative embodiment because the number of the vertical transfer paths 14 is one-half of the number of conventional vertical transfer paths. In the illustrative embodiment, signal charge stored in the photosensitive cells 12 positioned at opposite sides, i.e. the right-hand side and left-hand side, as viewed in FIG. 1, with respect to one vertical transfer path 14 are read out separately from each other via the same vertical transfer path 14. Such a signal charge readout scheme prevents different colors from being mixed together on the vertical transfer path 14.

More specifically, in the configuration shown in FIG. 1 or the optimized configuration shown in FIG. 2, signal charges stored in the photosensitive cells 12 located at, e.g. the left-hand side of any vertical transfer path 14 and to which color G is assigned are read out in a first video field, and then signal charges stored in the photosensitive cells 12 located at the right-hand side of the same vertical transfer path 14 and to which colors R and B are assigned are read out in a second video field. The readout from the left photosensitive cells 12 and the readout from the right photosensitive cells 12 are effected by drive signals V1 and V3, respectively. During an interval 30, see FIG. 3, lines (A) through (D), between the drive signals V1 and V3, the signal charges read out to the vertical transfer path 14 are transferred toward the horizontal transfer path 24 and then transferred via the horizontal transfer path 24, as stated previously.

The readout using the drive signals V1 and V3 are implemented by field shift gate pulses. More specifically, as shown in FIG. 3, line (B), the drive signal V1 has a waveform that is in its low level (L) at a time T1, rises to its medium level (M) at a time T2, further rises to its high level (H) at a time T3 and again falls to the low level via the medium level. In this case, a pulse appearing at the time T3 corresponds to a field shift gate pulse. This is also true with the drive signal V3 except that times T4 through T8 are substituted for the times T1 through T4, respectively.

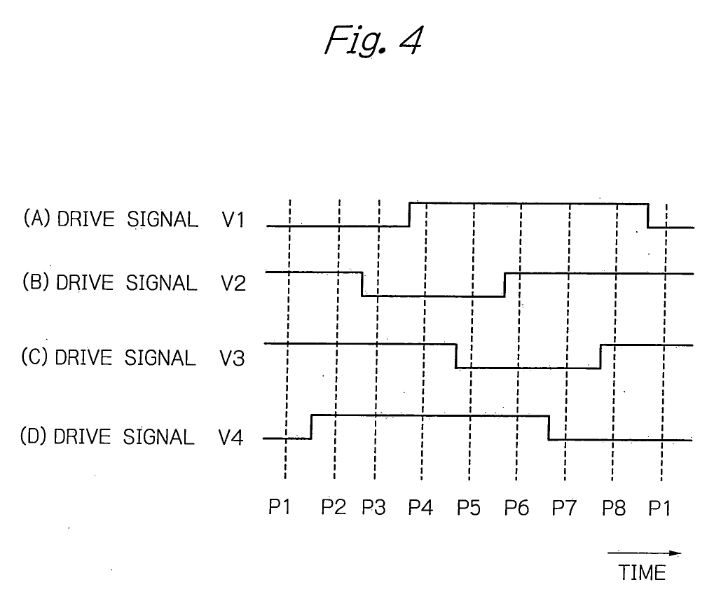

FIG. 4, lines (A) through (D), shows the drive signals V1 and V3 together with other drive signals V2 and V4 usually fed for the vertical transfer of signal charges. More specifically, FIG. 4, line (A) through (D), respectively show the drive signals V1 through V4 appearing during part of the interval 30 in an enlarged scale with respect to time. As shown, the drive signals V1 through V4 may be divided into eight consecutive phases P1 through P8. Signal charges read out from the photosensitive cells 12 are transferred in the vertical direction in response to the drive signals V1 through V4.

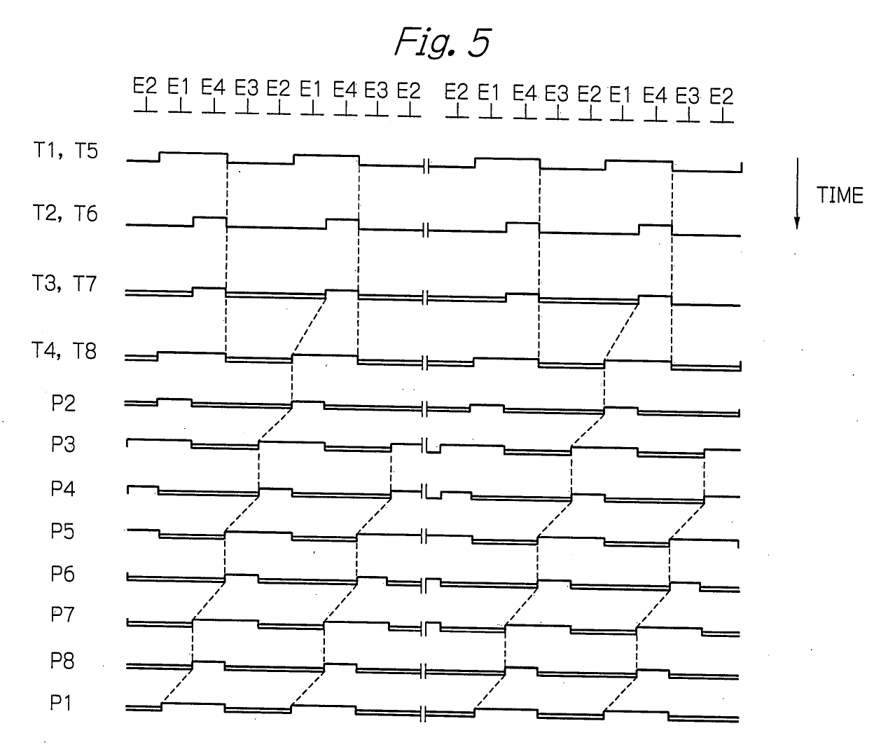

FIG. 5 is a potential chart demonstrates the vertical transfer of signal charges in terms of potentials. The drive signals V1 through V4 are respectively applied to transfer electrodes E1 through E4, which are associated with a respective CCD device or stage positioned on each vertical transfer path 14 each. As shown in FIG. 5, when the drive signals V1 through V4 are fed to the transfer electrodes E1 through E4, respectively, potential wells or packets are formed in the vertical transfer paths 14. More specifically, when a field shift gate pulse is applied to the transfer electrodes E1 at a time T3, signal charges of color G are read out. Also, when a field shift pulse is applied to the transfer electrodes E3 at a time T7, signal charges of colors R and B are read out. The drive signals V1 through V4 cause the signal charges thus read out to be sequentially transferred toward the horizontal transfer path 24 via the vertical transfer paths 14.

In the illustrative embodiment, all signal charges or pixels can be read out in two fields. By so switching the conventional arrangement and structure of photosensitive cells, it is possible to reduce regions for separating adjoining photosensitive cells, i.e. device or cell separating regions. More specifically, the illustrative embodiment is practicable with only one-half of the convention number of vertical transfer paths 14 and can read out signal charges in a plurality of fields to thereby reduce device separating regions. This successfully maintains the optical aperture area of the individual photosensitive cell large and therefore insures a sufficient signal charge even through the size of the individual photosensitive cell may be reduced to implement a highly integrated pixel arrangement, enhancing image sensor quality.

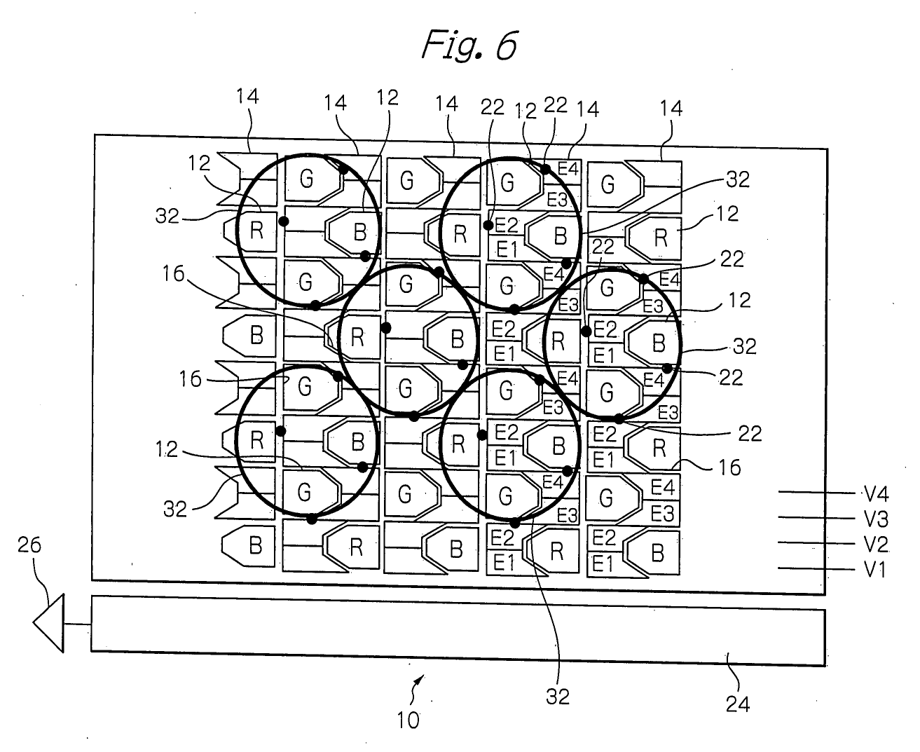

An alternative embodiment of the solid-state image sensor in accordance with the present invention will be described with reference to FIG. 6. In FIG. 6, structural parts and elements like those shown in FIG. 1 or 2 are designated by identical reference numerals. As shown, the illustrative embodiment is identical with the previous embodiment in that the vertical transfer path 14 is positioned every other column and in that color filter segments are arranged in a G square lattice, RB full-checker pattern. Also, the idle regions heretofore occupied by vertical transfer paths are assigned to the photosensitive regions 16 as in the previous embodiment, so that each photosensitive region 16 is larger in area than the conventional photosensitive region in the horizontal direction, as viewed in FIG. 6.

In FIG. 6, each photosensitive cell 12, forming a pixel, has its optical aperture basically identical in structure with the conventional aperture. With the alternative embodiment, it is possible not only to enlarge the aperture of the individual photosensitive cell 12 but also to reduce vignetting ascribable to the optical convergence characteristic and therefore to enhance resistivity to shading, as will be described more specifically later.

The number of the vertical transfer paths 14 is one-half of the number of vertical transfer paths arranged in the conventional CCD image sensor, as stated earlier. The transfer electrodes E1 through E4 constitute one group or unit on each vertical transfer path 14. In order to effectively use the vertical transfer paths 14, the transfer gates 22, represented by dots in FIG. 6, are positioned on those sides of the photosensitive cells 12 contacting the vertical transfer paths 14.

The transfer gates 22 of the alternative embodiment differ from those of the conventional CCD image sensor that they are not located at uniform positions with respect to the photosensitive cells 12. This is derived from the fact that, in the G square lattice, RB full-checker pattern shown in FIG. 6, four adjoining ones of the photosensitive cells 12 are dealt with as a unit or group as to each vertical transfer path 14, as shown with thick circles 32 in FIG. 6.

In the alternative embodiment, each of the units or groups 32 mentioned above consists of two photosensitive cells 12 with G color filter segments adjoining each other in the vertical direction and two photosensitive cells 12 with R and B color filter segments, respectively, adjoining each other in the horizontal direction in the vicinity of the above two photosensitive cells 12, as indicated by the thick circle 32 in FIG. 6. If desired, the two photosensitive cells with R and B color filter segments included in a unit 32 may be replaced with two photosensitive cells with B and R color filter segments, respectively, adjoining each other in the horizontal direction in the vicinity of two photosensitive cells 12 with G color filter segments adjoining each other in the vertical direction.

The instant alternative embodiment, handling each four photosensitive cells 12 as a unit, is characterized in that the transfer gates 22 assigned to such four photosensitive cells 12 are different in position from the transfer gates 22 of the previous embodiment shown in and described with reference to FIGS. 1 and 2. More specifically, as shown in FIG. 6, the transfer gate 22 assigned to the upper G photosensitive cell 12 included in each unit is positioned to output a signal charge stored in the G photosensitive cell 12 to the transfer electrode or CCD stage E4 in response to the ON/OFF of the drive signal V4.

As for the R photosensitive cells, when signal charges should be transferred by a single vertical transfer path, a transfer gate assigned to an R photosensitive cell would otherwise have been positioned in such a manner as to output a signal charge to a vertical transfer path located at the left-hand side. By contrast, in the alternative embodiment, the transfer gate 22 of each R photosensitive cell 12 is positioned at the opposite side to the conventional photosensitive cells mentioned above, outputting a signal charge stored in the R photosensitive cell 12 to the transfer electrode or CCD stage E2 in response to the ON/OFF of the drive signal V2.

On the other hand, the transfer gate 22 of each R photosensitive cell 12 outputs a signal charge stored in the R photosensitive cell 12 to the transfer electrode or CCD stage E1 in response to the ON/OFF of the drive signal V1. Likewise, the transfer gate 22 of each lower G photosensitive cell 12 included in the unit outputs a signal charge stored in the G photosensitive cell 12 to the transfer electrode or CCD stage E3 in response to the number of the drive signal V3.

Again, the signal charges read out from the photosensitive cells 12 are transferred by the vertical transfer paths 14 to the horizontal transfer path 24 disposed perpendicularly to the vertical transfer paths 14 and further transferred by the path 24 to the output amplifier 26 at high speed. The output amplifier or floating diffusion amplifier 26 converts the signal charges sequentially input thereto via the horizontal transfer path 24 to corresponding analog voltages, as stated previously.

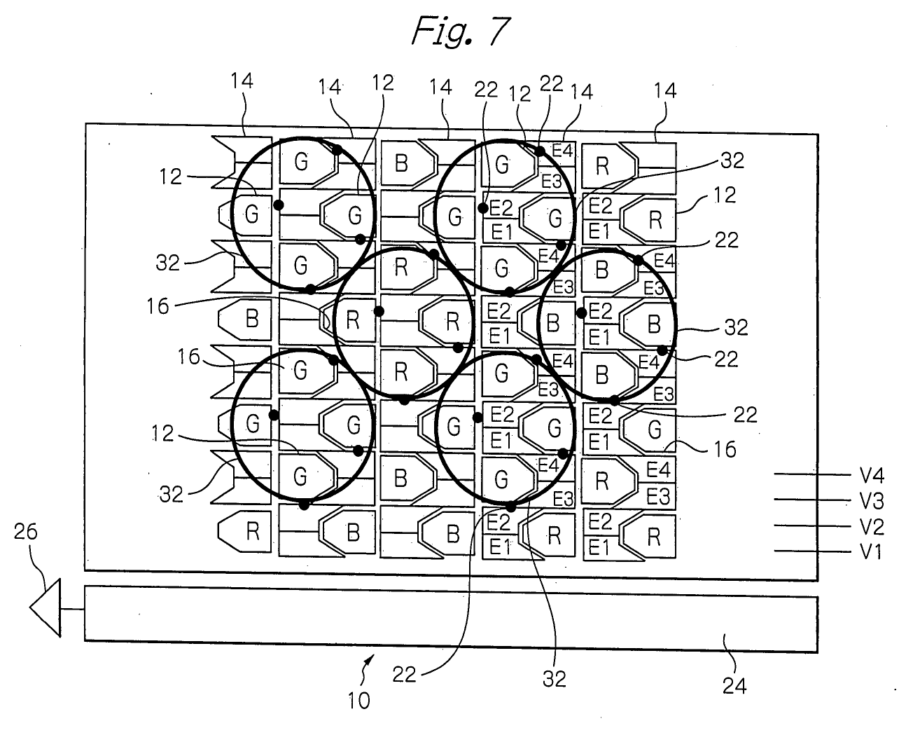

FIG. 7 shows a modified form of the alternative embodiment. As shown, the photosensitive cells 12 and vertical transfer paths 14 of the CCD image sensor are optimized in configuration such that they have an even area ratio, so that the centers of adjoining pixels form a square as in the conventional configuration in the same manner as in FIG. 2.

Further, the CCD image sensor 10 of FIG. 7 is characterized in that the color filter segments of the same color are combined to form a unit or group and in that such units are arranged in the G square lattice, RB full-checker pattern. In an application where the image sensor resolution of only one-fourth or one-half suffices with respect to the number of actual pixels, signal charges stored in the photosensitive cells 12 are read out from every four or two photosensitive cells 12, respectively. At this instant, the mixture of colors does not occur because signal charges so read out and then combined on the vertical transfer path 14 are of the same color.

A specific operation of the CCD image sensor 10 of the alternative embodiment will be described hereinafter. It has been customary with a CCD image sensor read out signal charges from its photosensitive cells by simultaneous readout of whole pixels. The simultaneous readout of whole pixels of however not applicable to the alternative embodiment because the number of the vertical transfer paths 14 is one-half of the number of conventional vertical transfer paths as in the previous embodiment.

The drive signals V1 through V4 are applied to the electrodes E1 through E4, respectively, for the transfer of signal charges. In the alternative embodiment, field shift pulses are sequentially fed in the order of the drive signals V3, V1, V2 and V4 fed field by field. Signal charges read out from the photosensitive cells 12 are transferred to the horizontal transfer path 24 as usual. It follows that, in the case of the color filter pattern shown in FIG. 6, four video fields in total are necessary for the signal charges of all pixels to be read out from the CCD image sensor 10 and form a single frame of image.

By contrast, in the optimized configuration of FIG. 7 in which four photosensitive cells 12 with color filter segments of the same color are arranged as a unit, as indicated by a bold circle 32, readout drive is so controlled as to apply field shift pulses to all of the drive signals, i.e. electrodes, V1 through V4 at the same time. Also, in the event of readout of signal charges, readout drive is so controlled as to apply field shift pulses to the drive signals V1 and V3 at the same time. Such signal readout should preferably be matched to a recording mode.

The readout scheme available with the optimized CCD image sensor 10 of FIG. 7 stated above mixes signal charges with each other on each vertical transfer path 14 and can read out signal charges in the same order of the colors as the conventional CCD image sensor. Therefore, conventional signal processing, i.e. preprocessing, automatic exposure (AE) control, automatic focus (AF) control and movie mode (MOVE; through-picture display mode) are applicable to the signal readout. Particularly, it is possible to mix signal charges at the preprocessing stage that does not need high resolution to thereby improve the imaging sensitivity and reduce a period of time necessary for reading out signal charges. More specifically, with the configuration of FIG. 7, it is possible to read out signal charges in one-fourth of a period of time necessary for the configuration of FIG. 6 to read them out.

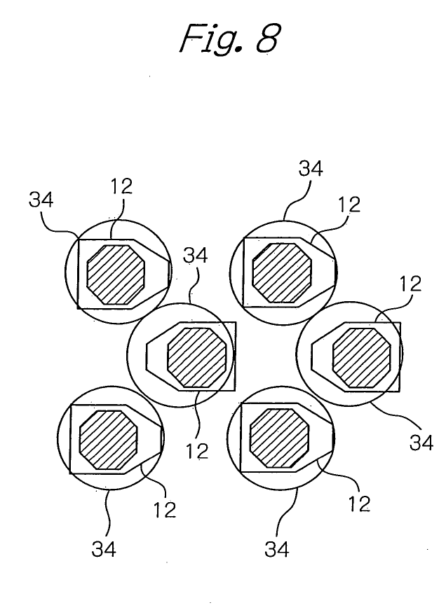

Further, as shown in FIG. 8, when the color filter segments are arranged in the pattern of FIG. 7, microlenses 34 should preferably be positioned in matching relation to the shape and position of the aperture of the individual photosensitive cell 12. More specifically, the readout of signal charges from the photosensitive cells 12 and mixing thereof are executed in dependence upon the zoom position. Generally, a digital camera with a CCD image sensor such as sensor 10, in many cases, includes a zoom mechanism in its optics. Generally, in the standard position of the zoom mechanism, when the angle of incident light beams having passed the edge of its exit pupil with respect to its focusing plane on which the light beams are focused tends to decrease, it is called that it lies on the acute angle or wide scope side. When the angle tends to increase, it is said that it lies on the obtuse angle or telescope side.

In the alternative embodiment, the aperture of the individual photosensitive cell 12 is provided with a horizontally elongated hexagonal shape greater in photosensitive area than the conventional regular octagonal shape. In the arrangement shown in FIG. 8, the microlenses 34 assigned to the photosensitive cells 12 on, e.g. the center row are slightly shifted to the left in the figure from the microlenses 34 on the other rows adjacent to the center row, i.e. toward the number of the focusing plane. Such an arrangement allows even light beams incident in the oblique direction to be accurately focused on the photosensitive areas of the photosensitive cells 12. On the other hand, the microlenses 34 assigned to the photosensitive cells 12 on the same column each are so positioned as to cover the entire photosensitive area of the corresponding photosensitive cell 12. This is because the photosensitive cells 12 shown in FIG. 8 are assumed to be positioned at the right-hand side of the center of the CCD image sensor 10 in the figure.

In the acute angle or telescope condition mentioned previously, field shift gate pulses are fed to the transfer gates 22 shown in FIG. 7 via the transfer electrodes E1 and E2 at the same time as the drive signals V1 and V2, respectively. As a result, signal charges are read out from the photosensitive cells 12 and then combined or mixed with each other over the vertical transfer paths 14. In the obtuse angle or wide angle condition, field shift gate pulses are applied to the drive signals V3 and V4 at the same time, so that signal charges are read out from the photosensitive cells 12 and then combined or mixed with each other.

By shifting the-positions of the microlenses 34 in accordance with the position of the individual photosensitive cell 12, as stated above, the alternative embodiment reduces the influence of the incidence angle in the peripheral pixel regions. Particularly, in the movie mode that requires real-time readout and signal processing, the alternative embodiment successfully reduces required time by mixed readout.

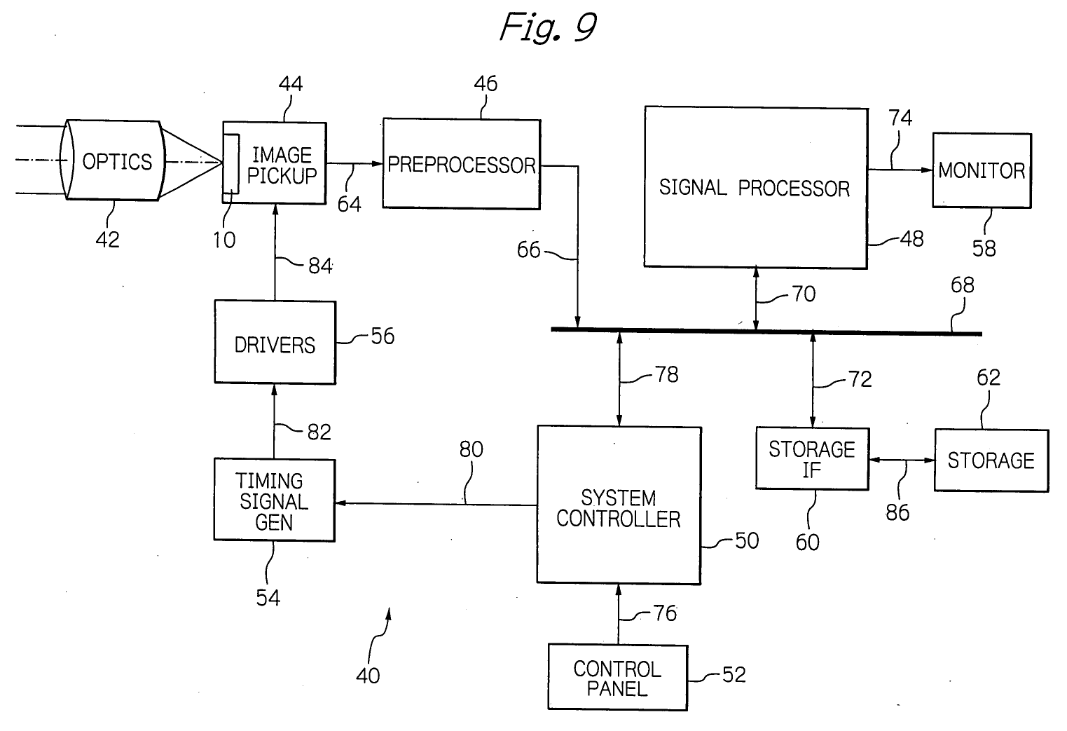

Reference will now be made to FIG. 9 for describing an image pickup apparatus including the CCD image sensor 10 of any one of the illustrative embodiments described above and implemented as a digital camera by way of example. As shown, the digital camera, generally 10, is generally made up of optics 42, an image pickup section 44, a preprocessor 46, a signal processor 48, a system controller 50, a control panel 52, a timing signal generator 54, drivers 56, a monitor 58, a storage interface (IF) 60 and a storage 6, which are interconnected as illustrated. Signals are designated by reference numerals attached to connections on which they are conveyed.

The optics 42 functions as capturing light beams incident from a subject field to be picked up to form an optical image with an angle of view controlled by the operation of the control panel 52. The optics 42 is structured to adjust the angle of view and focal distance in accordance with the zooming operation and/or the operation of a shutter release button, not shown, to its half-stroke position effected on the control panel 52. The half-stroke position of the shutter release button is distinguished from the full-stroke position of the button assigned to actual image pickup, as will be described more specifically later.

The image pickup section 44 includes the CCD image sensor 10, in which color filter segments are arranged in any one of the patterns described with reference to FIGS. 1, 2, 6 and 7. The color filter patterns shown in FIGS. 1, 2 and 6 are desirable when importance is attached to picture resolution because signal charges are read out from all pixels in, e.g. two or four field periods. On-the other hand, the color filter pattern shown in FIG. 7 allows signal charges to be read out to the vertical transfer paths 14 at the same time without any color mixture and transferred vertically and then horizontally, so that the signal charges can be rapidly read out in a single field period, compared to the color filter pattern of FIG. 6. However, the problem with the color filter pattern FIG. 7 is that spatial position information representative of four pixels is reduced to information on a single spatial position, resulting in a decrease in picture resolution.

The image pickup section 44 with the color filter pattern shown in FIG. 7 should preferably be operated selectively in a mode attaching importance to resolution or a mode not attaching importance thereto. When resolution is important, signal charges may be read out in, e.g. two field periods in a photo or still picture mode by of example. If resolution is not important, then signal charges should preferably be read out in units at the same time in each of the AE and AF control and the movie mode. Either one of such two importance modes is selected on the operation panel 52 by the operator, as will be described specifically later.

The image pickup section 44 is adapted to be operative in response to various signals 84 including the drive signals V1 through V4. The drivers 56 are adapted to generate the signals 84 in response to a timing signal 82 output from the timing signal generator 54 and feed them to the image pickup section 44. The image pickup section 44 is adapted to output an analog electric signal 64 produced by the CCD image sensor 10 to the preprocessor 46.

The preprocessor 46 has an AFE (Analog Front End) function. The AFE function includes cancelling noise contained in the analog electric signal 64 by correlated double sampling (CDS) and digitizing the resulting noise-free signal 64. The preprocessor 46 is adapted for producing digital image data 66 to the signal processor 48 over a bus 68 and a signal line 70.

The signal processor 48 is adapted to synchronize the image data 66 fed from the preprocessor 46 and use the resulting synchronized image data 66 to generate a luminance/chrominance (Y/C) signal, and further to convert the Y/C signal to a signal adaptive to, e.g. a liquid crystal (LC) display monitor. Further, the signal processor 48 selectively compresses the Y/C signal in a record mode or expands the compressed Y/C signal to reproduce the original Y/C signal in a reproduction mode. To the record mode, applicable is any one of a JPEG (Joint Photographic Experts Group) mode, an MPEG (Moving Picture Experts Group), a raw or RGB signal mode and other conventional modes. The signal processor 48 delivers the image data thus processed in the record mode to the storage or media interface 60 over the signal line 70, bus 68 and a signal line 72. Also, the signal processor 48 delivers a signal 74 formatted for an LC monitor to the picture monitor 58.

The system controller 50 serves as generating various control signals in response to an operation signal 76 received from the control panel 52 to control the overall operation of the camera 40. Particularly, the system controller 50 outputs a control signal matching with a photo or still picture mode, AE mode, AF mode or similar mode selected on the control panel 52. Estimated data, output from the signal processor 48, is fed to the system controller 50 over the signal line 70, bus 68 and a signal line 78. The system controller 50 feeds a control signal 80 matching with the mode selected on the operation panel 52 and estimated data to the timing signal generator 54.

The operation panel 52 includes a power switch, a zoom control button, a menu switch, a select key, a movie mode setting section and a continuous-shot seed setting section as well as the shutter release button mentioned previously, although not shown specifically. The control panel 52 is manipulated by the operator of the digital camera 40 to feed the system controller 50 with the operation signal 52, representative of a command consistent with the manipulation. The power switch is used to turn on or off the digital camera 40. The zoom button is used to vary the angle of viewing an imaging field including a desired subject for thereby adjusting the focal distance to the subject. The menu switch is manipulated to switch a menu being displayed on the monitor 58 and move a cursor on its monitor screen, and maybe implemented by direction keys or cross switch. The select key is depressed to select or determine desired one of various items listed on the menu.

The movie mode setting section is operated to determine whether or not to display movie pictures on the monitor 58 and may use the value of a flag to set. In accordance with the setting of the movie mode setting section, the pictures of the field being captured by the digital camera 40 are viewed on the monitor screen of the monitor 58 in the movie or through-picture mode.

The shutter release button is pushed by the first stroke to its half-stroke position and then by the second or further stroke to its full-stroke position for thereby selecting the operational timing and mode of the digital camera 40. More specifically, when the shutter release button is pushed to its half-stroke position, the digital camera 40 is caused to operate in the AE and AF modes in which an adequate lens opening, shutter speed and focal distance are determined on the basis of the image captured and hence displayed on the monitor 58 in the through-picture mode. Subsequently, when the shutter release button is pushed to its full-stroke position, a record start/end timing is defined and instructed to the system controller 50. The system controller 50 in turn defines an operational timing matching with the mode selected on the digital camera 40. The mode thus selectable may be the photo mode or the movie mode by way of example.

The timing signal generator 54 is designed to be in response to the control signal 80 input from the system controller 50 to generate various timing signals 82, including a vertical and a horizontal synchronous signal, a field shift gate signal, a vertical and a horizontal timing signal and an OFD (OverFlow Drain) signal for driving the image pickup section 44. The timing signals 82 are fed to the drivers 56.

The drivers 56 are adapted to generate a vertical and a horizontal dive signal and other signals in accordance with a drive mode represented by the timing signals 82 and feeds the drive signals 84 to the CCD image sensor 10 of the image pickup section 44. Further, the drivers 56 are adapted to responsive to the control signal to generate a zoom drive signal for selectively zooming in or out an imaging field to be captured by the optics 42. The zoom drive signal is fed to the zoom mechanism of the optics 42, although not shown specifically.

The storage or media interface 60 has an interface control function for controlling recording or reproduction of image data in or out of the storage 62 in matching relation to, e.g. the kind of a recording medium mounted in the storage 62. More specifically, the storage interface 60 may be adapted, as desired, to control the writing and reading of the image data 86 out of a PC (Personal Computer) card or similar semiconductor recording medium, or to control writing and reading under the control of a USB (Universal Serial Bus) controller included therein. Various kinds of semiconductor memory card standards are applicable to the storage 62.

The picture or video monitor 58 is implemented by, e.g. an liquid crystal display monitor, and serves as a visualizing as an image the image signal 74 input from the signal processor 48.

The operation of the CCD image sensor 10 shown in any one of FIGS. 1, 2, 6 and 7 and included in the digital camera 40 will be described hereinafter. An item to which importance is attached, and hence an operational mode, is dependent on the kind of the CCD image sensor 10 mounted on the digital camera 40.

More specifically, the image pickup section 44, when designed to include the CCD image sensor of FIG. 1 or 2, is driven in a two-field readout mode in the photo mode because importance is attached to picture resolution. On the other hand, the image pickup section 44, when designed to include the CCD image sensor 10 FIG. 6, is driven in a four-field readout mode. Further, the image pickup section 44, when designed to include the CCD image sensor of FIG. 7, is capable of effecting simultaneous readout and therefore driven in a single-field readout mode. The control panel 52 is so programmed as to adapt itself to any one of such different readout modes.

The system controller 52 generates the control signals 80 in response to the operation signal 76 input from the control panel 52 and feeds the control signals 80 to the timing signal generator 54. The timing signal generator 54, in turn, delivers the timing signal 82 to the drivers 56 in accordance with the control to be executed. In response to the timing signal 82, the drivers 56 provide the image pickup section 44 with the drive signal 84 to drive the latter.

In summary, it will be seen that the present invention provides a solid-state image sensor that allows device separating regions thereof to be reduced to a significant degree and therefore allows the optical aperture of the individual photosensitive cell thereof to be maintained large even if the size of the photosensitive cells is reduced to increase the number of pixels. This insures sufficient signal charges for thereby producing high-quality images free from deterioration. If an image sensor 10 pickup apparatus to which the above solid-state image sensor is applied is operable in accordance with the kind of the image sensor mounted thereon, then signal charges can be selectively read out over a plurality of field periods or a single field period, as desired. This provides the image pickup apparatus with high resolution, or alternatively provides it with a high-speed reading capability although resolution may be lowered.

It should be noted that while the present invention has been shown and described as being applied to a digital camera, it is similarly applicable to any other image pickup apparatus mounted on, e.g. a cellular phone, an image input apparatus, a PDA (personal digital assistant) or a personal computer.

The entire disclosure of Japanese patent application Nos. 2005-61905 and 2006-25915 filed on Mar. 7, 2005 and Feb. 2, 2006, including the specifications, claims, accompanying drawings and abstracts of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A solid-state image sensor comprising:
an array of photosensitive cells for capturing an image of a subject to generate signal charges representative of the image, photosensitive cells on any row being arranged at a pitch and shifted in a direction of the row by an interval from photosensitive cells on rows adjoining the row;
a plurality of column transfer paths for transferring signal charges read out from said array of photosensitive cells in a direction of a column;
a plurality of transfer gates for allowing the signal charges said array of photosensitive cells to be read out to said plurality of column transfer paths; and
a row transfer path for transferring the signal charges input from said plurality of column transfer paths in a direction of the rows;
each of said plurality of column transfer paths being formed at one side of every other column of said photosensitive cells,
each of said plurality of transfer gates being positioned between particular one of the photosensitive cells and particular one of the column transfer paths which is adjacent to said particular photosensitive cell at a side contacting said particular column transfer path.

2. The image sensor accordance with claim 1, wherein the interval lies in a range of substantially from one-third to one-fourth of the pitch, inclusive.

3. The image sensor in accordance with claim 1, wherein the signal charges of the image are read out over a plurality of field periods.

4. The image sensor in accordance with claim 2, wherein the signal charges of the image are read out over a plurality of field periods.

5. An image pickup apparatus comprising:
a solid-state image sensor for producing an image signal, said image sensor comprising an array of photosensitive cells for capturing an image sensor of a subject to generate signal charges representative of the image, photosensitive cells on any row being arranged at a pitch and shifted in a direction of the row by an interval from photosensitive cells on rows adjoining the row, a plurality of column transfer paths for transferring signal charges read out from said array of photosensitive cells in a direction of a column, a plurality of transfer gates for allowing the signal charges stored in said array of photosensitive cells to be read out to said plurality of column transfer paths, and a row transfer path for transferring the signal charges input from said plurality of column transfer paths in a direction of the rows;
a driver for generating a drive signal for driving said image sensor and feeding the drive signal to said image sensor;
a timing signal generator for providing said driver with a timing for generating the drive signal;
a controller for controlling said timing signal generator in response to an operation signal;
a control panel for feeding the operation signal to said controller; and
a signal processor for processing the image signal output from said image sensor;
each of said plurality of column transfer paths being formed at one side of every other column of said photosensitive cells,
each of said plurality of transfer gates being positioned between particular one of the photosensitive cells and particular one of the column transfer paths which is adjacent to said particular photosensitive cell at a side contacting said particular column transfer path.

6. The apparatus in accordance with claim 5, wherein the interval lies in a range of substantially from one-third to one-fourth of the pitch, inclusive.

7. The apparatus in accordance with claim 5, wherein the signal charges of the image are read out over a plurality of field periods.

8. The apparatus in accordance with claim 6, wherein the signal charges of the image are read out over a plurality of field periods.
